(19) United States
(12) Patent Application Publication
(10) Pub. No.: US 2024/0102842 A1
(43) Pub. Date: Mar. 28, 2024

(54) LASER FUEL MEASUREMENT DEVICE

(71) Applicant: Huan Zheng, Whippany, NJ (US)

(72) Inventor: Huan Zheng, Whippany, NJ (US)

(21) Appl. No.: 18/476,762

(22) Filed: Sep. 28, 2023

Related U.S. Application Data
(60) Provisional application No. 63/377,450, filed on Sep. 28, 2022.

(51) Int. Cl. G01F 23/292; B64D 37/04

(52) U.S. Cl. CPC G01F 23/292; B64D 37/04

(57) ABSTRACT

A laser fuel measurement device for the measurement of fuel levels within a fuel tank is disclosed. The laser fuel measurement device includes a case, a control panel, at least one laser sensor, and a microprocessor. The case is formed to fully house the microprocessor and at least partially house the control panel and laser sensor. The control panel may be formed on a first face of the case, and the laser sensor may be formed on a second face of the case opposite to the first face. The laser sensor is arranged to shine at least one laser beam or array into a fuel tank to measure fuel levels. The microprocessor stores and executes a fuel level average algorithm with which signals received from the laser sensor are processed to provide accurate and reliable fuel level measurements.

### CROSS-REFERENCE TO RELATED APPLICATION

This application claims the benefit of priority of U.S. provisional application No. 61/003,770, filed Sep. 28, 2022, the contents of which are herein incorporated by reference.

### BACKGROUND OF THE INVENTION

The present invention relates to fuel tanks and, more particularly, to a laser fuel measurement device for the measurement of fuel levels within a fuel tank.

Gas-powered vehicles using internal combustion engines are the dominant mode of transportation in the world today. Such vehicles require fuel tanks, gauges, and associated sensors that are reliable and accurate so that vehicle operators know when they need to refuel the vehicle. Traditional fuel sensors typically use a float sensor in fuel tanks where the float sensor relies on buoyancy to float up and down on the liquid fuel in the fuel tank to relay the fuel level to the fuel gauge and thus the vehicle operator. Such float sensors typically require a mechanical bar and float and can give inaccurate readings due to the float necessarily being partially submerged within the liquid fuel, and thus hitting the top or bottom of the fuel tank before the top of the liquid fuel does. Modern conventional fuel sensors may also be a capacitive type, wherein a capacitor is used to sense the position of fuel against a mechanical bar or tube that stands within the fuel tank. Often, traditional and conventional sensors break due to old or faulty moving parts. Further, in environments where the vehicle is not level, such as during off-roading or boating, traditional and conventional sensors often fail to register actual fuel levels due to their inability to cope with the shifting of liquid fuel within the fuel tank.

As can be seen, there is a need for a fuel sensor that is accurate and reliable, even when fuel is not in an optimal position for measurement, and that minimizes the use of moving parts. The present invention solves these problems by providing a laser fuel measurement device that relies on laser measurement to measure fuel levels reliably and accurately in all conditions. The laser fuel measurement device further eliminates the need for moving parts that are prone to breaking.

### SUMMARY OF THE INVENTION

In one aspect of the present invention, a laser fuel measurement device is provided. The laser measurement device comprises a case; a control panel formed at least partially within a first face of the case; wiring terminals formed on the first face of the case; at least one laser sensor formed at least partially within a second face of the case, wherein the second face is on an opposing side of the case relative to the first face; mounting holes extending through and between the first face and second face; and a microprocessor housed entirely within the case, wherein the microprocessor is electrically coupled to the control panel, wiring terminals, and at least one laser sensor.

In another aspect of the present invention, the laser fuel measurement device further comprises the case being formed of two halves fastened together via screws.

In another aspect of the present invention, the laser fuel measurement device further comprises the wiring terminals being electrically coupled to a fuel gauge.

In another aspect of the present invention, the laser fuel measurement device further comprises the microprocessor receiving signals and inputs from the control panel, the microprocessor processing the signals and inputs, and the microprocessor calibrating the at least one laser sensor based upon the signals and inputs.

In another aspect of the present invention, the laser fuel measurement device further comprises the microprocessor receiving signals and inputs from the at least one laser sensor, the microprocessor assessing the signals and inputs for fuel level measurements, the microprocessor using the fuel level measurements to calculate an average fuel level, and the microprocessor relaying the average fuel level to a fuel gauge through the wiring terminals.

In another aspect of the present invention, the laser fuel measurement device further comprises the at least one laser sensor being configured to measure fuel levels up to about 40 inches away from the sensor.

In another aspect of the present invention, the laser fuel measurement device further comprises a sensor mounting flange formed on the second face of the case, with the sensor mounting flange surrounding the at least one laser sensor.

In another aspect of the present invention, the laser fuel measurement device further comprises the sensor mounting flange extending away from the second face of the case.

In another aspect of the present invention, the laser fuel measurement device further comprises the sensor mounting flange aligning and sealing the case within an aperture in a fuel tank wall to which the case is mounted.

These and other features, aspects and advantages of the present invention will become better understood with reference to the following drawings, description, and claims.

### BRIEF DESCRIPTION OF THE DRAWINGS

FIG. 1 is a rear perspective view of a laser fuel measurement device in accordance with an embodiment of the present invention;

FIG. 2 is front perspective view thereof;

FIG. 3 is a rear elevation view thereof, showing wiring and component connections to a fuel gauge in accordance with the present invention; and

FIG. 4 is a perspective view thereof within an exemplary fuel tank.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a laser fuel measurement device for the measurement of fuel levels within a fuel tank. The laser fuel measurement device comprises a case, a control panel, at least one laser sensor, and a microprocessor. The case is formed to fully house the microprocessor and at least partially house the control panel and laser sensor. The control panel may be formed to be visible on a first face of the case such that a user may interact with the control panel to calibrate or control the laser fuel measurement device. The laser sensor may be formed to be visible on a second face of the case, wherein the second face is on an opposing side of the case relative to the first face. The laser sensor is visible on the second face of the case such that the laser sensor may shine at least one laser beam or array into a fuel tank to measure fuel levels. The microprocessor is electrically coupled to the control panel and laser sensor, such that the microprocessor may process signals or inputs received by the control panel to adjust the laser sensor or process signals from the laser sensor before sending such processed signals to a fuel gauge, e.g., via electrical wiring. The microprocessor may further store and execute a fuel level average algorithm with which signals received from the laser sensor are processed to provide accurate and reliable fuel level measurements.

It should be noted that the materials of manufacture for the present invention are not particularly limited. For example, the case may be formed of a metal, plastic, or any other material that is chemically unreactive with modern liquid fuels.

It should also be noted that the methods of manufacture for the present invention are not particularly limited. For example, the case may be formed via casting, molding, 3-D printing, or other known techniques.

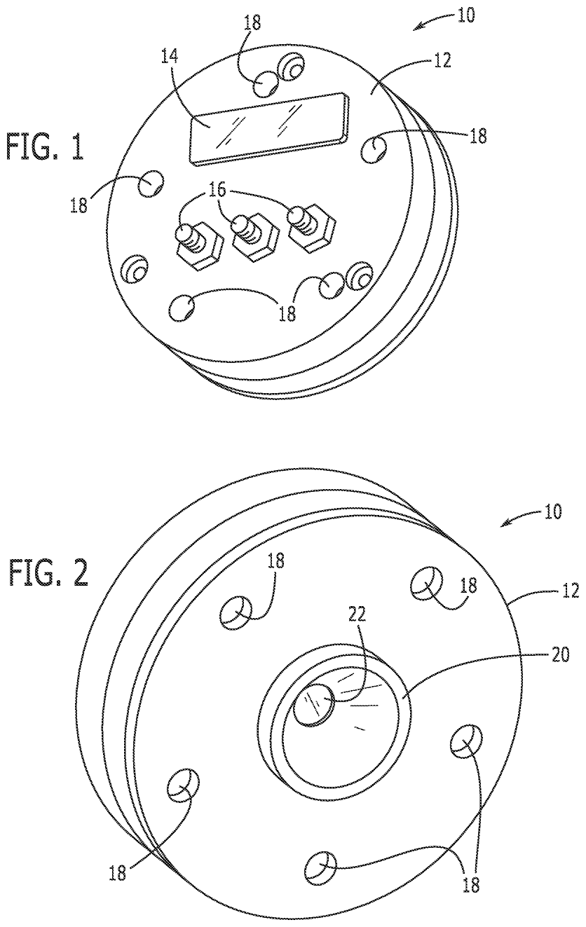

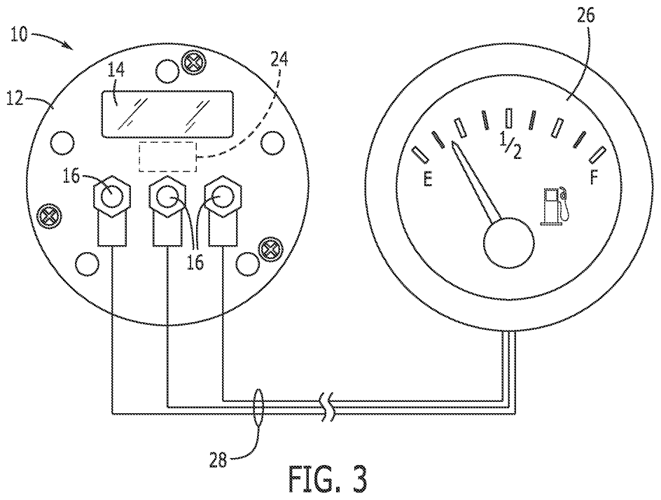

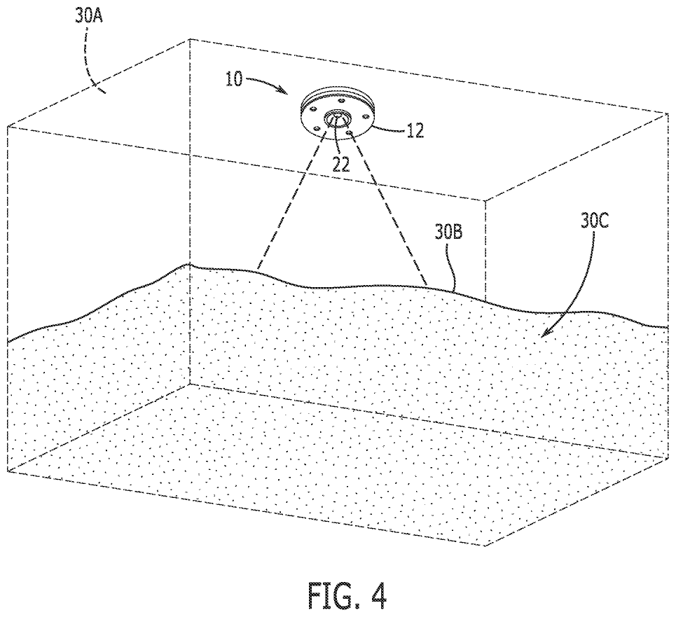

Referring to FIGS. 1-4, embodiments of a laser fuel measurement device in accordance with the present invention are shown. The laser fuel measurement device 10 comprises a case 12, a control panel 14, at least one laser sensor 22, and a microprocessor 24. The case 12 is formed to fully house the microprocessor 24 and at least partially house the control panel 14 and at least one laser sensor 22. The case 12 may be formed in two halves, with the two halves secured to one another via known fastening means, e.g., screws. The case may further comprise wiring terminals 16 that electrically connect the microprocessor 24 to a fuel gauge 26 via electrical wiring 28.

Mounting holes 18 are formed in the case 12 passing from a first face of the case to a second opposing face of the case 12 to allow the laser measurement fuel device 10 to be mounted to an interior or exterior surface of a fuel tank 30A, depending on a desired or needed configuration for the vehicle. In some embodiments, the mounting holes 18 are spaced evenly from one another proximal to an outer circumference of the case 12. The case 12 may be mounted to the fuel tank 30A via known fastenings means, e.g., nuts and bolts.

The control panel 14 may be formed to be visible on the first face of the case 12 such that a user may interact with the control panel 14 to calibrate or control the laser fuel measurement device 10. The control panel 14 may include a variety of means for the user to interact with the control panel 14, including, but not limited to, a dip switch (not shown), LED lights or signals (not shown), and buttons (not shown).

The at least one laser sensor 22 may be formed to be visible on the second face of the case 12, such that the at least one laser sensor 22 may shine at least one laser beam or laser array into the fuel tank 30A to measure fuel levels 30B. In preferred embodiments, the at least one laser sensor 22 may be centrally located within the second face of the case 12 and have a sensor mounting flange 20 surrounding the at least one laser sensor 22 and extending outwardly from the second face of the case 12. The sensor mounting flange 20 is configured to protect the at least one laser sensor 22 and, in some embodiments, align and seal the at least one laser sensor 22 within an aperture in a wall of the fuel tank 30A when mounting the laser fuel measurement device 10 to an exterior surface of the wall of the fuel tank 30A.

The microprocessor 24 is electrically coupled to the control panel 14 and at least one laser sensor 22, such that the microprocessor 24 may process signals or inputs received by the control panel 14 to adjust the at least one laser sensor 22. Additionally, the microprocessor 24 is configured to process signals from the at least one laser sensor 22. The microprocessor 24 then sends the processed laser signals to a fuel gauge 26 via the wiring terminals 16 formed on the first face of the case 12 and the electrical wiring 28 that electrically couples the wiring terminals 16 and fuel gauge 26. The microprocessor 24 may further store and execute a fuel level average algorithm with which signals received from the at least one laser sensor 22 are processed to assess, calculate and determine the average level of fuel 30C within the fuel tank 30A. The laser fuel measurement device 10 is thus able to provide accurate and reliable fuel level 30B measurements to the fuel gauge 26.

The laser fuel measurement device 10 is thus able to measure fuel levels 30B accurately and reliably with no moving parts and no components submerged into the fuel. The laser fuel measurement device 10 is capable of being calibrated for all fuel gauge types and provides accurate and reliable fuel level 30B measurements for fuel tanks 30A with depths up to 40 inches.

It should be understood, of course, that the foregoing relates to exemplary embodiments of the invention and that modifications may be made without departing from the spirit and scope of the invention as set forth in the following claims.

What is claimed is:

1. A laser fuel measurement device comprising:
a case;
a control panel formed at least partially within a first face of the case;
wiring terminals formed on the first face of the case;
at least one laser sensor formed at least partially within a second face of the case, wherein the second face is on an opposing side of the case relative to the first face;
mounting holes extending through and between the first face and second face; and
a microprocessor housed entirely within the case, wherein the microprocessor is electrically coupled to the control panel, wiring terminals, and at least one laser sensor.

2. The laser fuel measurement device of claim 1, wherein the case is formed of two halves fastened together via screws.

3. The laser fuel measurement device of claim 1, wherein the wiring terminals are further electrically coupled to a fuel gauge.

4. The laser fuel measurement device of claim 1, wherein the microprocessor receives signals and inputs from the control panel, the microprocessor processes the signals and inputs, and the microprocessor calibrates the at least one laser sensor based upon the signals and inputs.

5. The laser fuel measurement device of claim 1, wherein the microprocessor receives signals and inputs from the at least one laser sensor, the microprocessor assesses the signals and inputs for fuel level measurements, the microprocessor uses the fuel level measurements to calculate an average fuel level, and the microprocessor relays the average fuel level to a fuel gauge through the wiring terminals.

6. The laser fuel measurement device of claim 5, wherein the at least one laser sensor is configured to measure fuel levels up to about 40 inches away from the sensor.

7. The laser fuel measurement device of claim 1, wherein a sensor mounting flange is formed on the second face of the case, with the sensor mounting flange surrounding the at least one laser sensor.

8. The laser fuel measurement device of claim 7, wherein the sensor mounting flange extends away from the second face of the case.

9. The laser fuel measurement device of claim 7, wherein the sensor mounting flange aligns and seals the case within an aperture in a fuel tank wall to which the case is mounted.
